(19) United States
(12) Patent Application Publication
(10) Pub. No.: US 2015/0296342 A1
(43) Pub. Date: Oct. 15, 2015

(54) Portable Device And Method For The Geolocation And Continuous Location Of An Object Moving In A Constrained Environment

(71) Applicant: Commissariat a l'energie atomique et aux energies alternatives, Paris (FR)

(72) Inventors: Mehdi Boukallel, Gif Sur Yvette (FR); Florian Periquet, Laxou (FR); Guillaume Trehard, Mainvilliers (FR)

(73) Assignee: Commissariat a L'energie atomique et aux energies alternatives, Paris (FR)

(21) Appl. No.: 14/234,376

(22) PCT Filed: Jul. 19, 2012
(86) PCT No.: PCT/EP2012/064150

§ 371 Date: Apr. 25, 2014

(30) Foreign Application Priority Data
Jul. 22, 2011 (FR) 11 56669
Oct. 6, 2011 (FR) 11 59036

(51) Int. Cl. H04W 4/02; G01C 21/20; H04W 64/00

(52) U.S. Cl. CPC H04W 4/027; H04W 4/021; H04W 64/006; G01C 21/206

(57) ABSTRACT

The invention includes a portable device and a method for the geolocation and continuous location of an object moving in a constrained environment. This device includes:
means to determine the movement speed vector of this object by anemometer reading able to make measurements of relative wind caused by the movement of the object, and to deliver a corresponding signal,
means for processing this signal able to calculate the speed vector of this object and its position.

### TECHNICAL FIELD

The invention relates to a device and a method for the geolocation and continuous location of an object moving in a constrained environment. Assistance with the guiding of an object is one of the invention's possible applications.

### STATE OF THE PRIOR ART

The field of the invention is that of devices for geolocation and continuous location used in embedded fashion in mobile devices, for example mobile telephones, tablet computers or laptop PCs (personal computers), or on mobile devices (mobile robots, vehicles, pedestrians, etc.) targeting civil applications (for example navigational aids) or security applications (for example surveillance), implying a requirement for positioning in situations where conventional approaches by GPS (Global Positioning System) are inoperative. The term “geolocation” designates geographical and therefore absolute location, unlike the term “location”, which designates a relative location.

Geolocation and continuous location by satellite (GPS) solutions are now widely sold and used in very many mass applications. But the efficacy of these solutions is lessened, or even non-existent, in “indoor” or constrained environments, such as areas of high urban density (“urban canyons”, i.e. high residential density urban configurations), or within a closed enclosure (a building, underground area, tunnel, hall, etc.). There is a glaring discontinuity between outdoors and indoors in terms of geolocation and continuous location.

Two major families of solutions exist to resolve this problem of geolocation and continuous location in a constrained environment. In a first family the concepts are based on the following techniques:
A-GPS (indoor GPS),
RFID (Radiofrequency Identification),
UWB (Ultra Wide Band), UHF (Ultra High Frequency),
WiFi (Wireless Fidelity),
ID-Cellular,
GSM/3G,
Bluetooth (short-distance radio technology).

In a second family, which is that of the invention, concepts based on the following techniques may be mentioned:
Vision,
Inertial,
Ultrasound,
Infrared,
Magnetic,
SLAM (Simultaneous Localisation And Mapping).

Most of the solutions used currently (A-GPS, WiFi, UWB, etc.) require heavy and costly infrastructure to operate. The quality and accuracy of these solutions depends largely on how densely these infrastructures are deployed, since they make use of triangulation, using at least three beacons.

Other solutions (Vision, SLAM) make use of concepts of measurement of optical flow, image recognition or 3-D reconstitution of the surrounding space. These solutions must process a very substantial data stream, and therefore require substantial computing resources, limiting their compactness and portability.

A less invasive solution, in terms of infrastructure and portability, relies on the use of inertial and gyroscopic or magnetic sensors. What Due to substantial aberrations caused by the use of such sensors, their use remains limited to configurations with controlled parameters (for example the walking of a pedestrian, running, etc). Such sensors require complex signal-processing algorithms (which are costly in terms of computer resources) to provide possibilities of mobility.

One object of the invention is to resolve these problems of geolocation and continuous location in constrained environments, when the GPS/GSM signals are weak or unavailable (urban canyon, building, underground area, etc.), in particular for a pedestrian application or application on any other mobile entity moving in this specific environment (trolley, robot, vehicle, etc.).

The document referenced [1] at the end of the description describes “indoor” location techniques for a moving robot or moving targets and navigation techniques for a pedestrian.

Another object of the invention is to compensate for the disadvantages of the prior art by proposing a device and a method which do not require that specific infrastructures are established, and allowing:
precise geolocation (to within less than one metre), and continuous location in constrained environments, without pre-equipping the location,
great compactness (a few cm³) compared to the existing systems, enabling embedded applications to be made possible,
to compensate for the substantial aberrations of sensors in the devices of the known art (notably inertial sensors).

### DESCRIPTION OF THE INVENTION

The invention relates to a portable device for the geolocation and continuous location of an object moving in a constrained environment, characterised in that it includes
means to determine the movement speed vector of this object by anemometer reading able to make measurements of relative wind caused by the movement of this object, and to deliver a corresponding signal,
means for processing this signal able to calculate the speed vector of this object and its position.

The device of the invention advantageously includes a unit for displaying this position. It may also include a geopositioning device.

Advantageously these means for determining the speed vector include at least one airspeed sensor, which is advantageously co-linear with the movement of the body.

The device of the invention may advantageously include means for combining output data from this at least one airspeed sensor with data derived from at least one sensor of the inertial, magnetic, barometric or radio type, where these means enable geolocation and location in three dimensions to be addressed.

The means for determining the speed vector advantageously use one of the following techniques:
hot-wire measurement,
ultrasound measurement,
pressure gradient measurement.

The mechanical assembly of each airspeed sensor on the device of the invention is advantageously one of the following assemblies:
assembly with open flow,
assembly with directional flow,
assembly with Pitot flow.

Optimum performance is obtained by an airspeed tube of the Pitot type.

The invention also relates to a mobile device, for example of the Smartphone or GPS or tablet computer or vehicle or robot type, including such a device, which is fitted to this mobile device.

This device advantageously includes a portable device including a unit for displaying the three-dimensional position of the moving object, and allowing assistance with guidance.

The invention also relates to a method for the geolocation and continuous location of an object moving in a constrained environment, characterised in that it includes:
a step of determining the movement speed vector of this object by anemometer reading able to make measurements of relative wind caused by the movement of this object, and to deliver a corresponding signal,
a step of processing this signal able to calculate the speed vector of this object and its position.
The method of the invention advantageously includes a unit for displaying this position.

The method of the invention advantageously includes a step of combining anemometer reading data with data derived from at least one sensor of the inertial, magnetic, barometric or radio type. It may also include a step of prior calibration.

In the invention the use of an airspeed sensor enables the following advantages to be obtained:
The device of the invention has little or no drift (of less than a factor 5 lower than inertial approaches).
It is compact (a few cm³), meaning that it can be incorporated into a non-invasive portable device.
It requires only small amounts of signal processing, due to the fact that its position is obtained by integrating a speed vector, and not by complex use of accelerometer or gyroscopic data, or again magnetic data.
It may be used in any application requiring geolocation and continuous location in a constrained environment where GPS signals do not operate, or when it is not desired to deploy outdoor infrastructures (beacons, pseudolites), unlike location and geolocation approaches of the known art (by WiFi, GNSS (“Global Navigation Satellite System”), UWB (“Ultra Wide Band”), GSM (“Global System for Mobile Communication”), etc.), for which transmitting beacons are positioned in the environment. Indeed, the device of the invention is based on measuring relative windspeed, and does not require that the location be fitted beforehand. The data obtained is directly made measurements of speeds of the moving object. The movement measurements are deduced by simple mathematical integration (order 1) of the airspeed data.

The device of the invention can target the following application fields:
security and surveillance,
isolated worker,
moving robotics,
guidance in a constrained environment (indoors)
geolocated service and content for the general public,
intervention in unknown environments (GIGN, military, etc.)

### BRIEF DESCRIPTION OF THE ILLUSTRATIONS

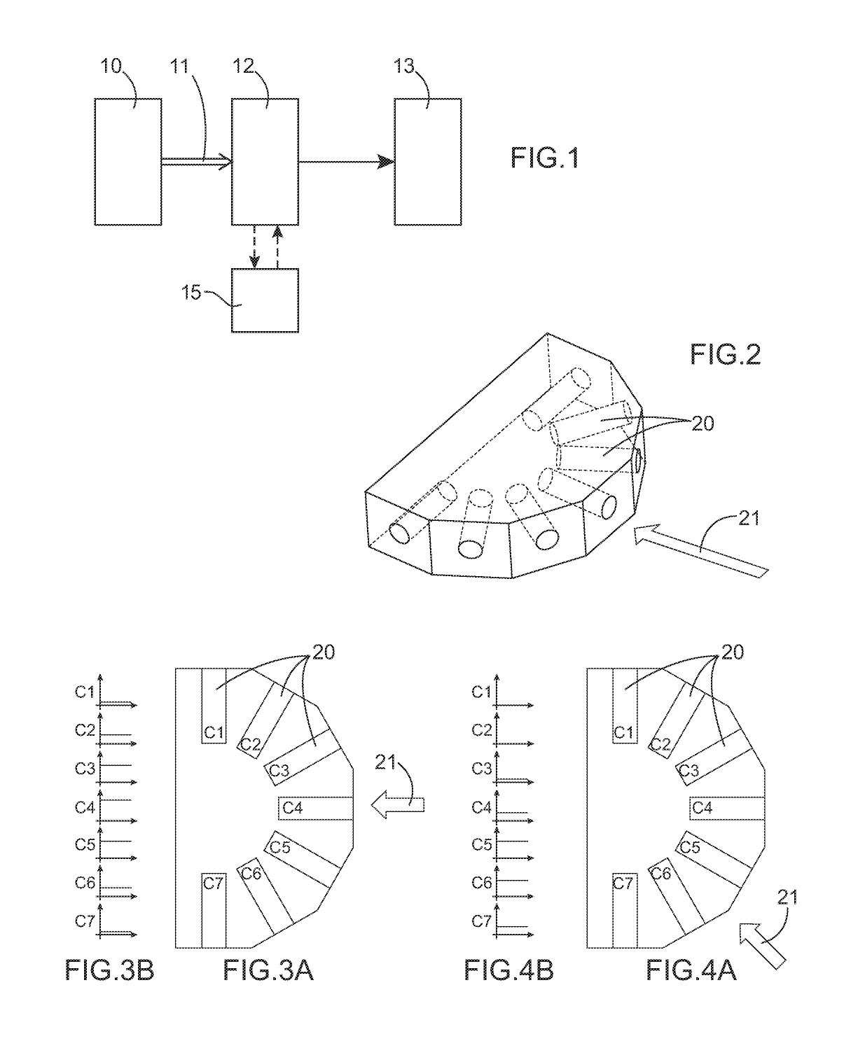

FIG. 1 illustrates the device for geolocation and continuous location of an object moving in a constrained environment according to the invention.

FIG. 2 illustrates a set of airspeed sensors and the incident relative windspeed.

FIGS. 3A to 4B illustrate the signals from a set of airspeed sensors and the representation of two stream components.

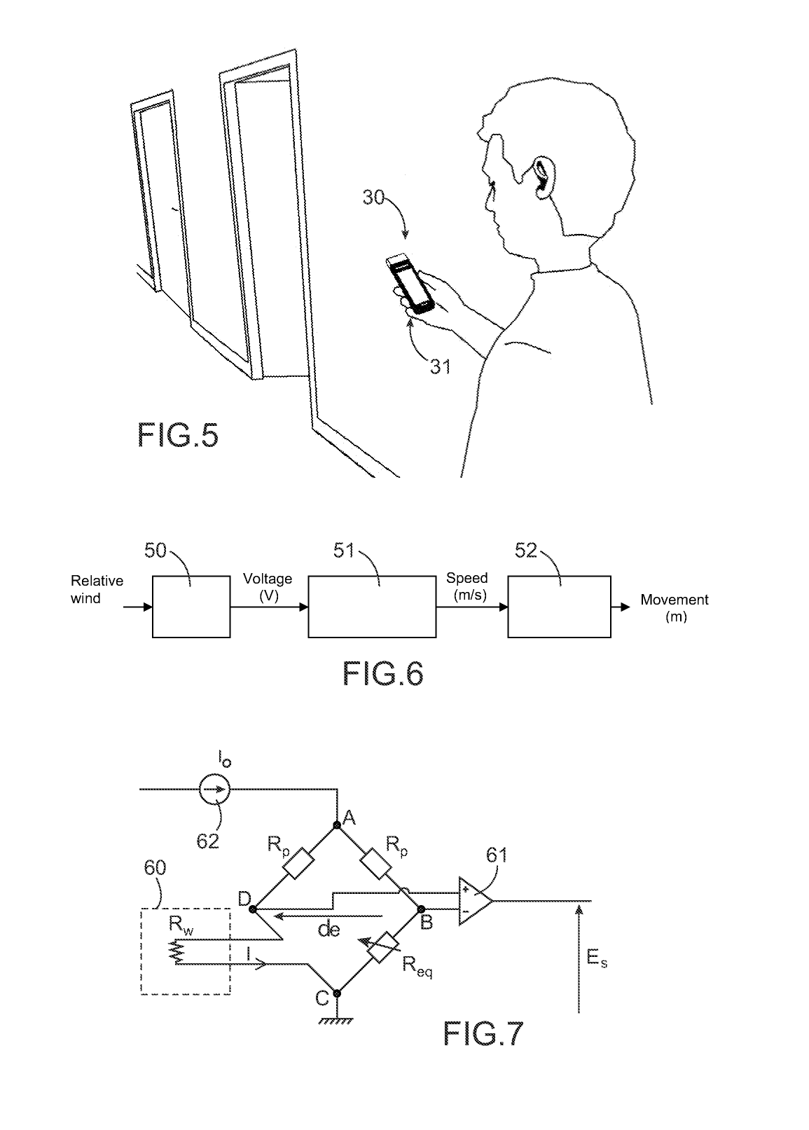

FIG. 5 illustrates use of the device of the invention, with a display of location, in a constrained environment.

FIG. 6 illustrates a block diagram representing the operation of the acquisition and processing chain of the device of the invention.

FIG. 7 illustrates an example of an electrical diagram of a constant-current anemometer.

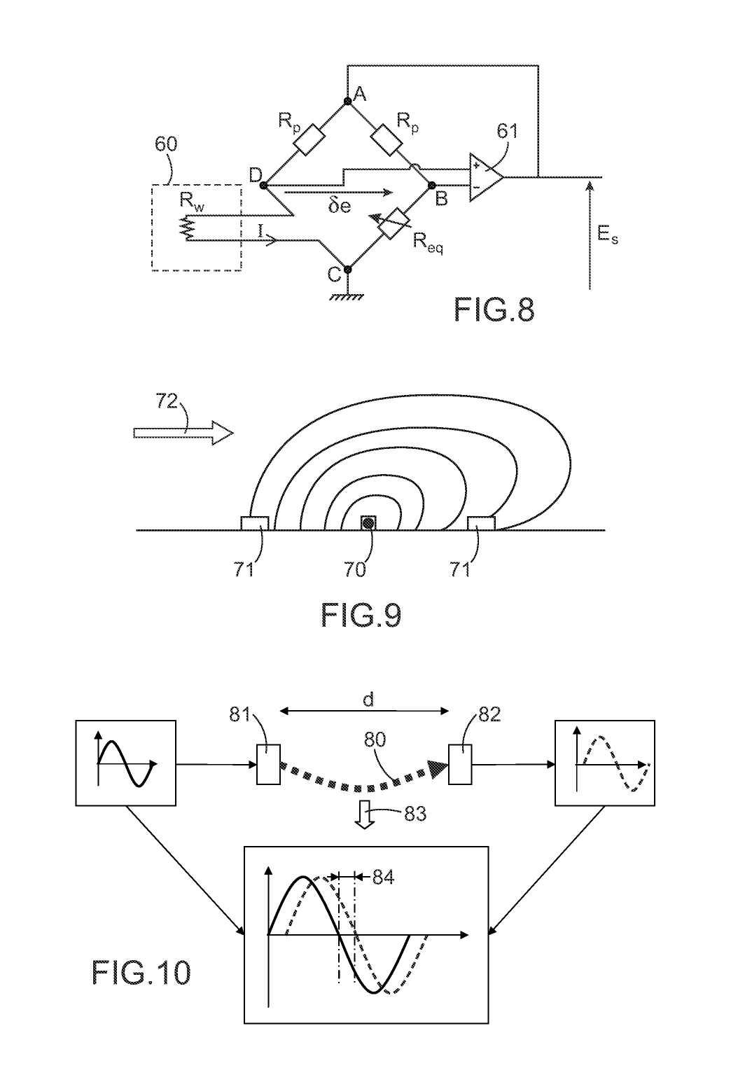

FIG. 8 illustrates an example of an electrical diagram of a constant-temperature anemometer.

FIG. 9 illustrates an example of a principle used by a hot-wire anemometer MEMS sensor.

FIG. 10 illustrates the schematic diagram of an acoustic wave anemometer.

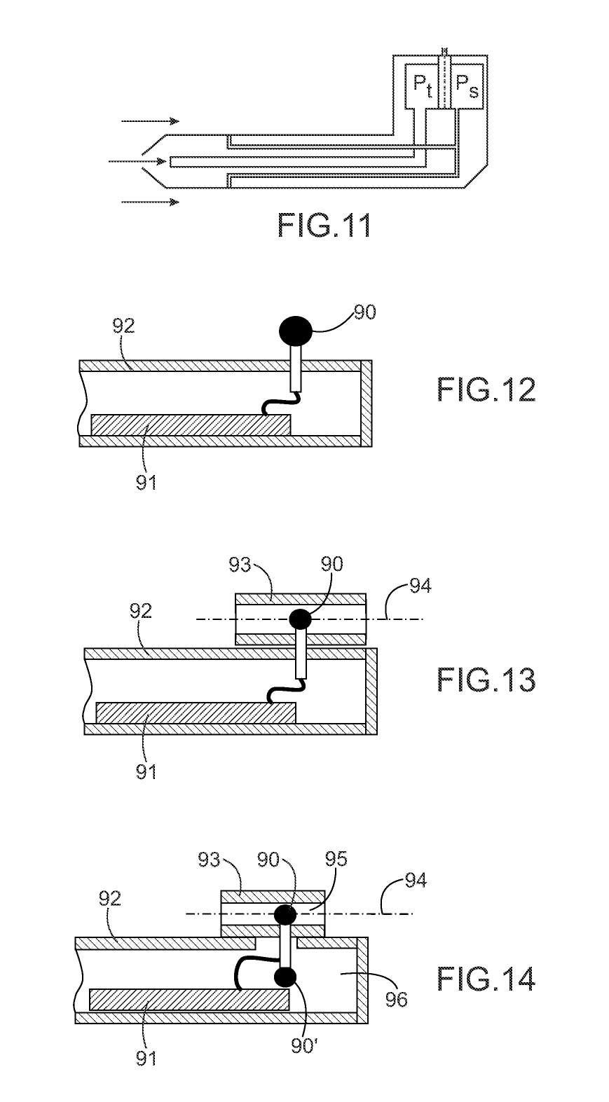

FIG. 11 illustrates the schematic diagram of a pressure gradient anemometer.

FIG. 12 illustrates an example of an airspeed sensor with open flow.

FIG. 13 illustrates an example of an airspeed sensor with directional flow.

FIG. 14 illustrates an example of an airspeed sensor with Pitot flow.

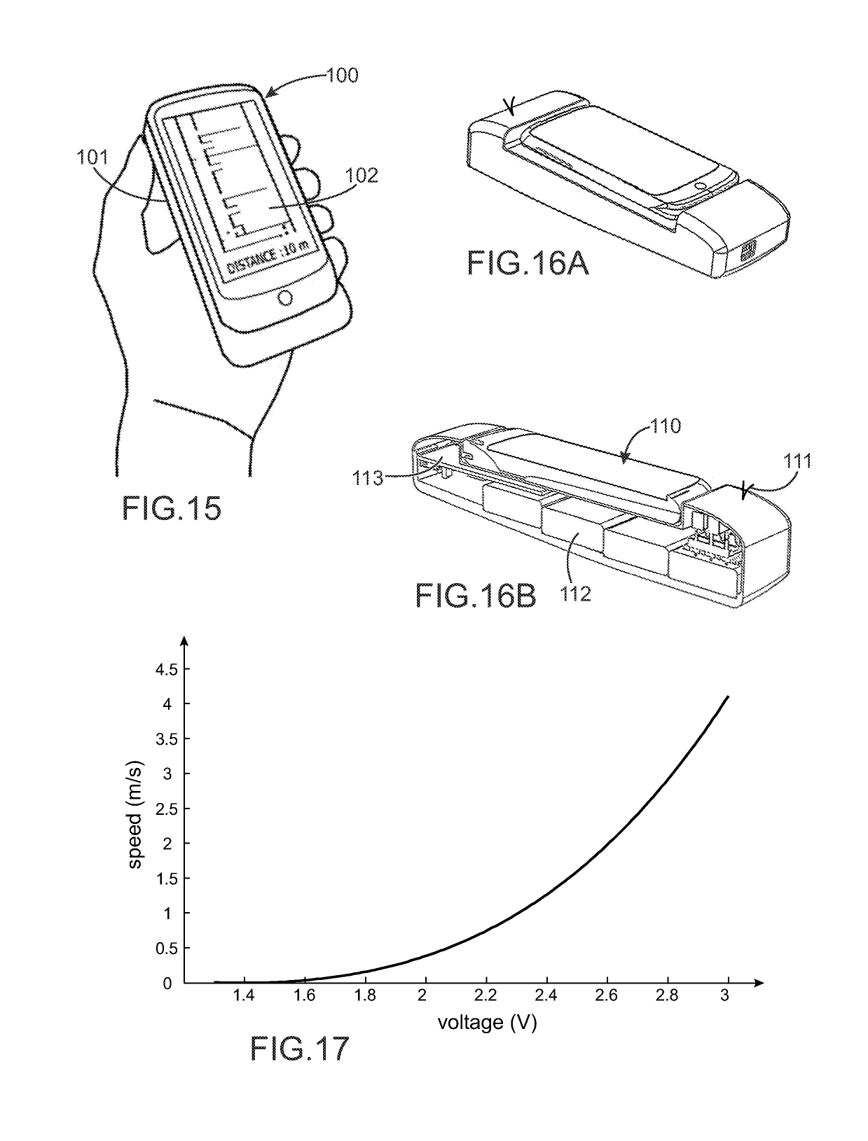

FIG. 15 illustrates a mobile device according to the invention (Smartphone and airspeed device) and an associated graphics unit.

FIGS. 16A and 16B illustrate an example 1D hot-wire and open flow embodiment, respectively as a front view and as a section view.

FIG. 17 illustrates the characteristics corresponding to the example embodiment illustrated in FIGS. 16A and 16B.

FIG. 18 illustrates a second example embodiment of a 1D hot-wire open-flow solution.

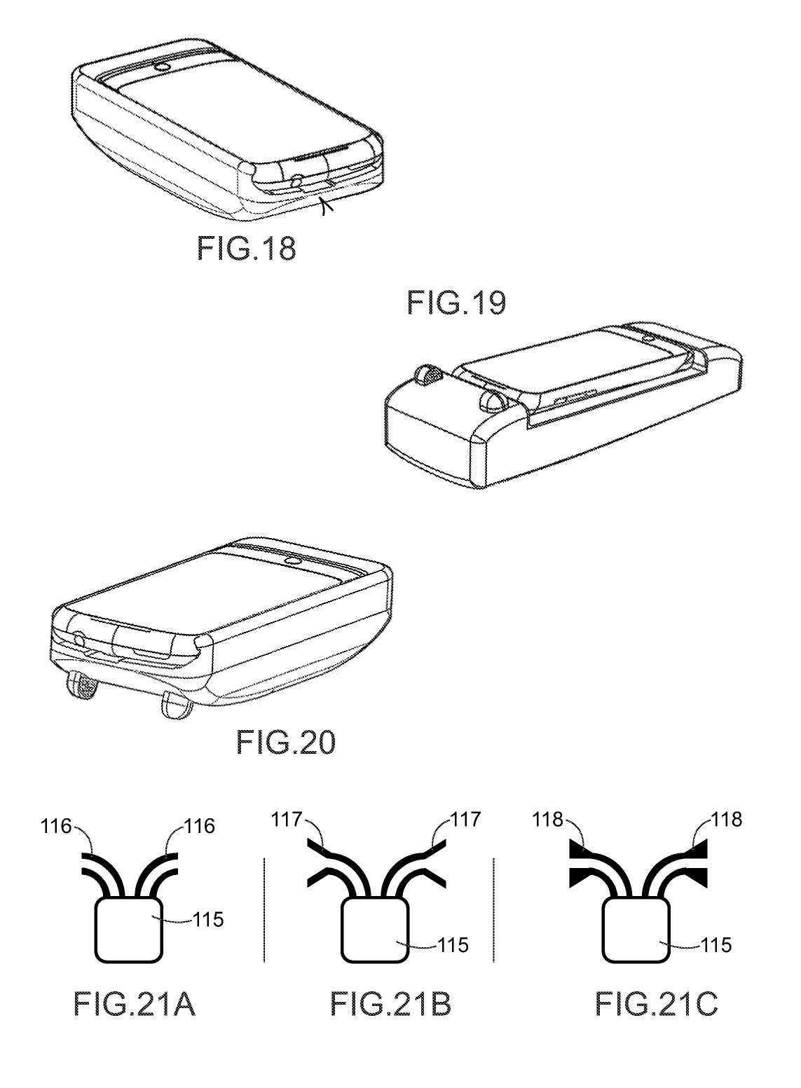

FIGS. 19 and 20 illustrate two example embodiments of a 1D ultrasound and open flow solution.

FIGS. 21A to 21C illustrate three joining pieces for an anemometer solution by pressure differential, respectively with an through hole, with a cone, and with a plane.

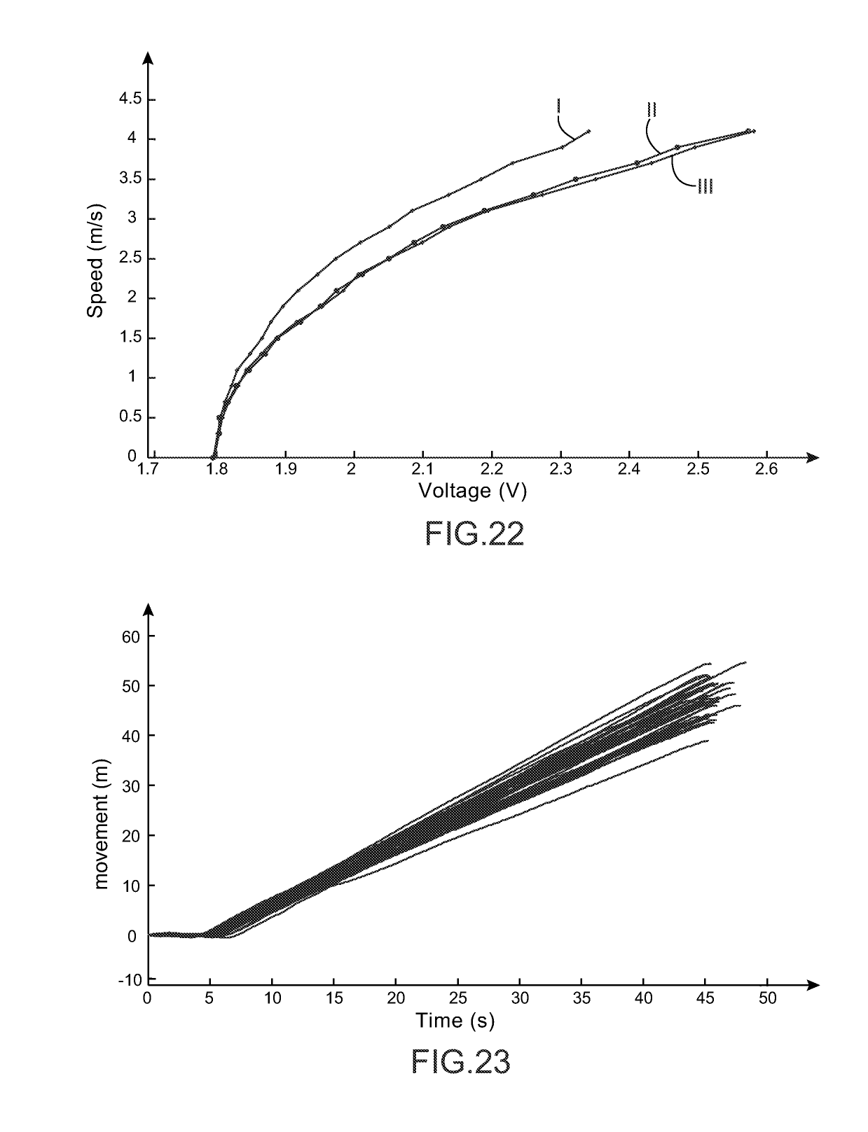

FIG. 22 illustrates a comparison of the use of three bidirectional joining pieces illustrated in FIGS. 21A to 21C.

FIG. 23 illustrates the movements obtained over forty 49 m tests with a 1D pressure differential anemometer.

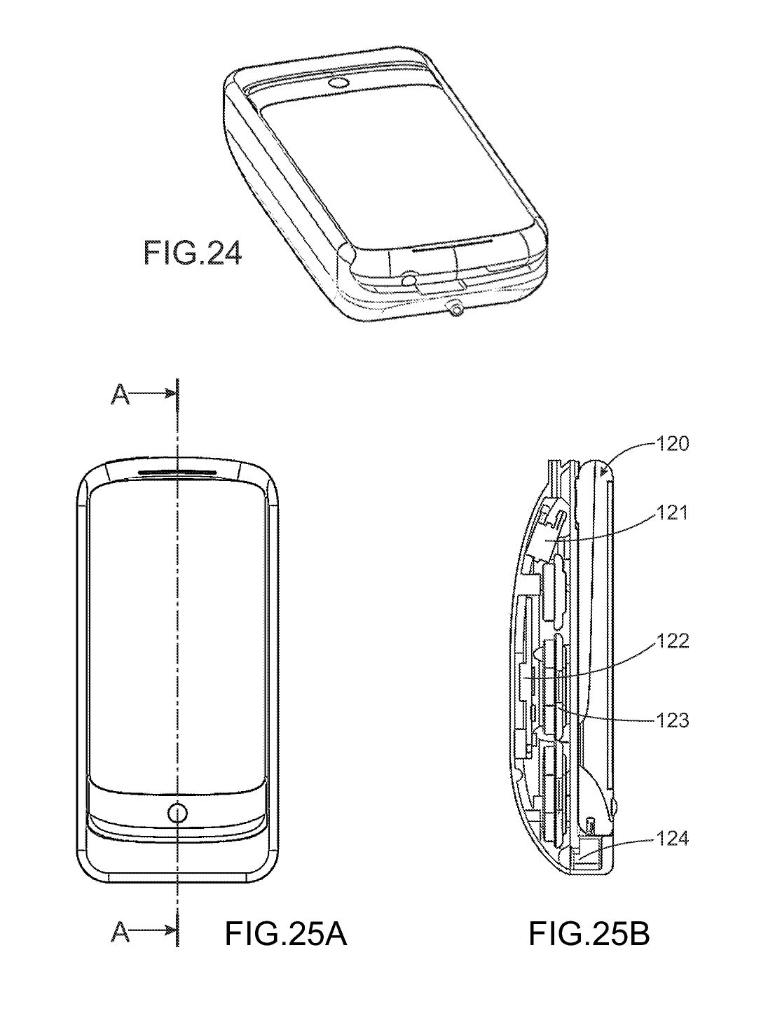

FIG. 24 illustrates a 1D example embodiment of a pressure differential and Pitot flow anemometer.

FIGS. 25A and 25B illustrate details of the example illustrated in FIG. 24, respectively as a front view and as an AA section view.

### DETAILED DESCRIPTION OF PARTICULAR EMBODIMENTS

The invention relates to a portable device for geolocation and continuous location of a moving object incorporating a passive method, which allows the movement speed vector of this moving object to be determined by anemometer reading, and the position of this object at any time to be determined by integration of the speed vector, where an integrated display unit allows real-time display of this position.

The device of the invention takes the form of an airspeed sensor coupled with or integrated in a device of the smartphone/GPS/tablet computer type, or any other device having possibilities for arithmetic computation able to move in a constrained environment, where the flow patterns are known and controlled. Ultimately it enables the user to evaluate its relative and absolute position, or the position of a moving object fitted with this device. The device of the invention allows geolocation and continuous location in a constrained environment, in which the use of GPS waves is impossible, through the use of a method for measuring the relative speed of the wind created around the moving object.

In what follows the context of a pedestrian application, in which the airspeed sensor and the data acquisition and processing means are associated with a commercially available mobile terminal of the smartphone type, is more specifically considered. Three measuring methods for the airspeed approach (hot-wire, ultrasound and pressure gradient) are thus considered, since different approaches are adopted in the context of the mobility of a pedestrian. But the use of the device of the invention with other terminals (PC, robot, vehicle, etc.) in other applications is easily conceivable.

The device of the invention illustrated in FIG. 1 includes at least one airspeed sensor 10, intended to make measurements of relative wind (flow produced by the moving object), which is positioned such that it is sensitive to the relative wind speed variations caused by the movement of this object. Airspeed sensor 10 enables the physical magnitude of the relative wind speed to be transformed into a physical magnitude 11 taking the form of an electrical potential or an electrical current. Processing means 12 enable the speed vector of the said moving object and its position to be determined from such a signal. A display unit 13 displays this position determined by the device of the invention in real time. It includes, for example, a standard display (display screen). But it can also use the display functions of a mobile terminal (smartphone, tablet computer, etc.).

In one variant embodiment a traditional geopositioning device (GPS, inertial, etc.) 15 is used, connected to processing means 12, as illustrated in FIG. 1. When this geopositioning device 15 no longer receives positioning data (for example when the person, the object or the vehicle moves inside a building), the device of the invention takes over and provides a data element representing the speed vector and/or the position of the moving body to this geopositioning device 15, which can then determine the position of the moving body in a constrained environment. This function enables the disadvantages of the prior art to be overcome, and the context of transition from outdoors to indoors to be addressed. In addition, geopositioning device 15, which may contain inertial sensors, can supply processing means 12 with data from these inertial sensors, in order to complete the computation of the position obtained by the device of the invention. Geopositioning device 15 is advantageously able to perform this positioning computation.

The device of the invention therefore includes at least one airspeed sensor, the integration of which in a moving body enables the relative wind speed to be measured (flow produced by the moving body) around the body when it moves. This device may be used in an environment in which the flow patterns are known or controlled, for example in a constrained environment (building, hall, tunnel, underground area, etc.). If the flow patterns are not known a calibration phase may be envisaged to determine the model of the environment. This calibration phase takes the form of experimental measurements of flow speeds in the different environments where the moving body is to move. The sensor and the body then form the innovative assembly enabling the body's location to be determined. Use of at least one airspeed sensor, with little or no drift (of less than a factor 5 lower than inertial approaches), makes for relatively compactness (a few mm³) and requires little signal processing. The expression “little signal processing” makes reference to the contrary case, where a large volume of computation resources is required to extract the location using conventional approaches (for example, inertial approaches). In the invention, the position of the body is therefore derived from a single integration of a speed vector, and not from the complex use of the accelerometer and gyroscopic data, or again magnetic data, in the case of an inertial unit, and is not based on the use of external elements of the beacon type, which are complex infrastructures which must be deployed in the environment where the moving object is to move, either for reasons of costs, or for reasons of encumbrance, in order to determine a location in an environment where it is impossible to use GPS signals. The airspeed sensor and the body then form a self-contained indivisible and functional whole.

The position of the airspeed sensor providing the best measuring sensitivity is the one in which the aperture angle of airspeed sensor 20 is colinear with the stream 21 which is to be measured, as illustrated in FIG. 2. Multiple sensors 20 (C1-C7), which are differently aligned, thus enable the different components of the stream to be detected, as illustrated in FIGS. 3A and 4A. The signals obtained, which are illustrated in FIGS. 3B and 4B, correspond to the different sensors C1-C7.

The device of the invention may nevertheless use all or some of the means enabling location in a constrained environment to be undertaken. It is thus possible to perform a data merge with sensors of the inertial, magnetic, barometric, radio, etc. type, which may already be contained in the object (for example a smartphone, tablet computer, etc.), in order to obtain improved location accuracy, as illustrated in FIG. 5. Reference 30 relates to an airspeed sensor, and reference 31 to the moving object. The expression “merging of data” means a software hybridisation technique enabling the best use to be made of each sensor without degrading general measuring performance.

In the context of the envisaged pedestrian application the useful measuring range in terms of speed is 0 m/s to 5 m/s. Three airspeed measuring techniques are thus considered:
hot-wire measurement,
ultrasound measurement,
pressure gradient measurement.

Depending on the requirements, it is possible to use one or other of these techniques to measure the relative wind speed for one to six dimensions (three translation axes and three rotation axes). Each measuring method used in this fashion exploits the combination of an airspeed measuring technique and a mechanical assembly enabling the flows to be exploited optimally.

The three airspeed measuring techniques mentioned above were tested in a pedestrian application within a building. Repeatability tests showed the feasibility of the method in one axis of movement. The multi-axes problem (three translations, three rotations) may be addressed by duplicating the airspeed sensors and positioning them appropriately in line with the preferential axes of movement. The feasibility study also related to the quantification of the sensitivity of the device of the invention to ambient disturbance (temperature variations, meeting the path of another person, air currents, etc.). Finally, the post-processing algorithm, based on computation of the first-order integration, was transferred to a mobile terminal of the smartphone type. The choice was made in favour of this terminal in order to favour mobility in the context of this pedestrian application. But any other terminal may be envisaged (tablet computer, microprocessor card, robot, vehicle, etc.).

### DETAILED DESCRIPTION OF INVENTION

The method of geolocation and continuous location by airspeed measurement according to the invention has several possible configurations. Each configuration exploits the combination of a technique for airspeed measurement and of mechanical assembly of the airspeed sensor on the device of the invention enabling flows to be exploited optimally.

The airspeed measuring techniques can be the following:
hot-wire anemometry,
ultrasound anemometry
pressure gradient anemometry.
The mechanical assembly configurations can be the following:
assembly with open flow (airspeed sensor not encapsulated),
assembly with directional flow,
assembly with Pitot flow.

The effective combinations are defined in table 1 at the end of the description:

The block diagram of the acquisition and processing chain of the device of the invention is shown in FIG. 6. There is thus, in succession, an airspeed sensor 50, a post-processing unit (filtering characteristic, etc.) 51 and a first-order integration unit 52.

Measuring methods which perform satisfactorily for the targeted pedestrian application are thus described below:

Hot-Wire Anemometry

The thermal exchange is then measured between an electrical conductor heated by the Joule effect and the moving air in its vicinity. The variation of the conductor's electrical resistance is directly correlated with the speed of the fluid traversing it. Hot wires with constant current or with constant temperature are commonly used as conductors. In FIGS. 7 and 8, a bridge with four resistors arranged as a lozenge is considered, where the two resistors of the two upper branches are resistors of determined value Rₚ, and the two resistors of the lower branches are respectively a calibration resistor Req and a resistor Rw, which is a hot-wire sensor 60. The common point of the two lower branches C is connected to earth, and the common points of the upper and lower branches B and D respectively to the − and + inputs of an operational amplifier 61. In FIG. 7 the point common to the two upper branches A is connected to a constant-current source 62. Conversely, in FIG. 8 this common point A is connected to the output of operational amplifier 61. In the first configuration with constant current illustrated in FIG. 7, the hot-wire sensor 60 is powered by the constant-current source 62. When the airspeed sensor is traversed by a fluid the resistance of the sensor is modified. The change of resistance is directly correlated with the speed of the fluid. In the second configuration illustrated in FIG. 8 the current is held constant by a feedback loop controlled by the variation of the speed of the fluid traversing it. This second configuration provides a measuring dynamic which is of greater use in quantifying transient phenomena (pedestrian walking, shuffling, etc.).

An anemometer with constant temperature verifies an equation of the following form:

Eₛ²=A+B, Vⁿ

where V is the flow speed, Eₛ the measured voltage and A, B, n constants obtained by calibration.

Recent progress in the integration of electronic components has enabled airspeed MEMS (Micro Electro-Mechanical Systems) sensors to appear, a functional example of which is illustrated in FIG. 9. These sensors enable the problem of measuring relative wind speed to be resolved in a manner similar to the method of measurement by hot wire described above, with particularly advantageous compactness and cost, aspects which are very useful in the field of the invention. In this FIG. 9 a hot wire 70, temperature-sensitive resistors 71, and flow 72 are represented.

Ultrasound Anemometry

The speed of propagation of ultrasound waves (path 80) illustrated in FIG. 10 depends on the intrinsic properties of the traversed medium. By exploiting this phenomenon in a medium of the air type, the flow speed of the air between two fixed points may be determined. The airspeed measurement is made possible through the use of a transmitter 81 and a receiver 82 which are separated by a calibrated distance d. The signal transmitted by transmitter 81 is subject to a time lag (phase shift 84) measured by the receiver 82, the amplitude of which depends directly on the speed of the fluid traversing the region between the transmitter 81 and the receiver 82. Arrow 83 represents the relative wind.

Pressure Gradient Anemometry

A pressure differential or gradient between two specific points, where one is exposed to the flow (relative wind) P the second is exposed to static atmospheric pressure as illustrated in FIG. 11, is measured. Through the sensor this pressure gradient produces a voltage proportional to the square of the speed of movement.

Three mechanical assembly configurations are considered:

An Assembly with Open Flow

As illustrated in FIG. 12, airspeed sensor 90 is exposed and directly measures the speed of the relative wind. Reference 91 is an acquisition device and reference 92 is a protective shell. As illustrated in this figure, airspeed sensor 90 (hot-wire, or ultrasound, or pressure gradient) is exposed to impacts and subject to wear and tear.

An Assembly with Directional Flow

The airspeed sensor 90, having satisfactory measuring sensitivity, is subject to saturation. It may be positioned in a structure 93 which attempts to make the flow laminar (measuring direction 94), with elimination of turbulence caused by measuring irregularities, as illustrated in FIG. 13. Such a structure 93 enables the sensor 90 to be protected mechanically against impacts and breakage. There are then several possibilities for positioning and encapsulating the sensor. The nature of the flows within this structure 93 is identified and characterised in order to interpolate the speed of the stream. The nature of the flows depends on the intrinsic geometry of the terminal ends of this structure 93.

An Assembly with Pitot Flow

Such an assembly is conceivable only in the case of speed measurement by pressure difference. Since such an assembly, illustrated in FIG. 14, is similar to a construction of the Pitot type, a pressure differential measurement is made between two specific points 95 and 96 by using two airspeed sensors 90 and 90′, one of which is exposed to the flow (relative wind), and the second of which is exposed to static atmospheric pressure. The pressure gradient obtained produces a voltage proportional to the speed of movement.

The examples and the results presented above are for devices suitable for single-axis measurement; they may however be extended to six dimensions. As illustrated in table 2 at the end of the description, the anemometry method of the invention enables single-axis measurements to be addressed. To obtain a device suitable for 3D location positioning, the following associations are possible:
1 anemometer+1 inertial unit (that of the smartphone in the case of pedestrian location)
3 anemometers+3 gyroscopes
3 anemometers+3 magnetometers

In the first case the anemometer is an additional means of correcting the inertial measurements, whereas in the second case full use is made of the technique of location by anemometry, but the number of anemometers is tripled.

In the context of the pedestrian application in question, a graphics unit enables the 3D (three-dimensional) position of, and distance travelled by, the user of the device in the plane of their movement environment (previously entered) to be displayed. A mobile device (smartphone 100 and airspeed and processing device 101) and an associated graphical interface 102 are thus illustrated in FIG. 15. The means of location by airspeed measurement are sufficiently compact to be housed in an external unit which is fitted in a universal manner to a smartphone. This device, which is capable of “Plug & Play”, may be produced for this type of application, with the desired precision. Such an all-in-one unit, which is easy to use and compact for the user, is very advantageous in light of the mobility requirements required by this type of development for the general public.

### Example Embodiments

Several example embodiments obtained with the airspeed measurement techniques and the mechanical assembly configurations described above to locate a pedestrian are now considered.

### 1D Hot-Wire and Open-Flow Anemometer Example Embodiment

FIGS. 16A and 16B illustrate an example of a hot-wire and open-flow solution. In FIG. 16B a smartphone 110, a 1D hot-wire sensor 111, batteries 112 and a processing card 113 are illustrated. FIG. 17 illustrates the characteristics for this solution.

FIG. 18 illustrates a second example embodiment of a 1D hot-wire open-flow solution.

### 1D Ultrasound, Open-Flow Anemometer Example Embodiments

FIG. 19 illustrates a second example embodiment of a 1D ultrasound open-flow solution.

FIG. 20 illustrates a second more compact example embodiment of a 1D ultrasound open-flow solution.

### 1D Pressure-Differential, Directional Flow Anemometer Example Embodiments

FIGS. 21A, 21B and 21C illustrate three joining pieces 116, 117 and 118 designed for an anemometry solution by differential: through hole, cone and plane, where reference 115 is the airspeed sensor. FIG. 22 illustrates the comparison of the characteristics of these three bidirectional joining pieces 116, 117 and 118: through hole:curve I; Cone: curve II; Plane: curve III.

FIG. 23 illustrates the movements obtained over forty 49 m tests with a 1D pressure differential anemometer example embodiment.

FIG. 24 illustrates a 1D example embodiment of a pressure differential and Pitot flow anemometer. FIGS. 25A and 25B illustrate details of this 1D pressure differential and Pitot flow anemometer example embodiment. A smartphone 120, a differential sensor 121, an acquisition card 122, batteries 123 and a USB connection 124 are illustrated in FIG. 25B.

TABLE 1
Possible combinations between anemometry techniques and flow type

| | Hot-wire | Ultrasound | Pressure gradient |
|---|---|---|---|
| Open | X | X | |
| Directional | X | X | X |
| Pitot | | | X |

TABLE 2
Extension to 3 dimensions of the device of the invention

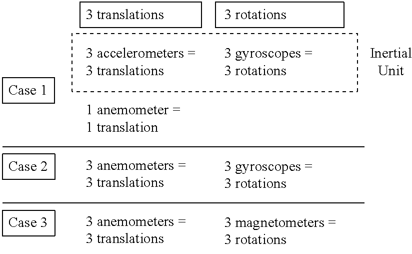

### REFERENCES

[1] “Indoor mobile robot and pedestrian localization techniques” of Hyo-Sung Ahn and Wonpil Yu (“International Conference on Control, Automation and Systems 2007”, 17-20 Oct. 2007, COEX, Seoul, South Korea).

1. A portable mobile device, which includes:
a device for geolocation and for continuous location this device in a constrained environment, which GPS signals cannot be used, including:
means for anemometric reading of the air flow produced by the moving device, enabling the physical magnitude of the measured wind speed to be transformed into an electrical potential signal or corresponding electrical current signal,
means for processing this signal able to calculate the speed vector of this device and its position.
an integrated display unit for allowing real-time display of this position

2. (canceled)

3. A device according to claim 1 including a geopositioning device.

4. A device according to claim 1, in which these means for determining a speed vector include at least one airspeed sensor.

5. A device according to claim 4, in which at least one airspeed sensor is colinear with the movement of this object.

6. A device according to claim 4, including means for combining data from this at least one airspeed sensor with data deriving from at least one sensor of the inertial, magnetic, barometric or radio type.

7. A device according to claim 1, in which the means for determining the speed vector use one of the following techniques:
hot-wire measurement,
ultrasound measurement,
pressure gradient measurement.

8. A device according to claim 4, in which the mechanical assembly of each airspeed sensor on the device of the invention is one of the following assemblies:
assembly with open flow,
assembly with directional flow,
assembly with Pitot flow.

9. (canceled)

10. A device according to claim 1, which is a device of the smartphone/GPS/tablet computer/vehicle/robot type.

11. A device according to claim 1 including a portable device including a unit for displaying the three-dimensional position, and allowing assistance with guidance.

12. A method for geolocation and continuous location of a mobile device moving in a constrained environment, in which GPS signals cannot be used, which includes:
a step of determining the movement of this device by anemometer reading able to make measurements of the air flow produced by the movement of this device, and to deliver a corresponding signal of an electrical potential signal or corresponding electrical current,
a step of processing this signal able to calculate the speed vector of this device,
a step location of this device by integration of the speed vector,
a step of display of this position.

13. (canceled)

14. A method according to claim 10, which includes a step of combining anemometer reading data with data derived from at least one sensor of the inertial, magnetic, barometric or radio type.

15. A method according to claim 10, including a prior calibration step.
